(19) United States
(12) Patent Application Publication
(10) Pub. No.: US 2015/0181278 A1
(43) Pub. Date: Jun. 25, 2015

(54) DISPLAY APPARATUS AND DISPLAY METHOD THEREOF

(71) Applicant: SAMSUNG ELECTRONICS CO., LTD., Suwon-si (KR)

(72) Inventors: Yeo-ri YOON, Cheongju-si (KR); Han-soo KIM, Seongnam-si (KR); Dong-heon LEE, Seoul (KR)

(73) Assignee: SAMSUNG ELECTRONICS CO., LTD., Suwon-si (KR)

(21) Appl. No.: 14/564,597

(22) Filed: Dec. 9, 2014

(30) Foreign Application Priority Data
Dec. 24, 2013 (KR) 10-2013-0162131

(51) Int. Cl. H04N 21/422; H04N 21/472; H04N 21/482

(52) U.S. Cl. CPC H04N 21/42218; H04N 21/482; H04N 21/47217; H04N 21/42208; H04N 21/42227; H04N 21/42224

(57) ABSTRACT

A display apparatus is provided. The display apparatus may include a receiver configured to receive a command to display a virtual remote controller from a remote controller, a display configured to display a virtual remote controller which is divided into a plurality of UI areas including items with different properties according to the virtual remote controller display command, and a controller configured to magnify a size of one UI area from among the plurality of UI areas according to a received manipulation, and control to display additional information regarding at least one item included in the magnified UI area.

### CROSS-REFERENCE TO RELATED APPLICATIONS

This application claims priority from Korean Patent Application No. 10-2013-0162131, filed in the Korean Intellectual Property Office on Dec. 24, 2013, the disclosure of which is incorporated herein by reference in its entirety.

### BACKGROUND

1. Field

Apparatuses and methods consistent with exemplary embodiments relate to a display apparatus and a display method thereof, and more particularly, to a display apparatus which applies a virtual remote controller and a display method thereof.

2. Description of the Related Art

Recently, with developments in display technology, the display industry has developed at a rapid speed. Accordingly, remote control devices such as remote controllers which control a display apparatus have developed rapidly along with display apparatuses.

A remote controller now does not require a number of key buttons on a surface of the remote controller. Rather, remote controllers are now capable of controlling a display apparatus using a touch pad, a virtual remote controller, etc. A virtual remote controller refers to a group of menu items disposed on a certain area of the display screen of a display apparatus. Generally, menu items disposed on the virtual remote controller are not mounted on a remote controller.

A conventional virtual remote controller may include a plurality of User Interface (UI) screens having items with different respective properties, A UI screen including an item with one property may be displayed first on the display screen, and then a UI screen including another item with a different property may be displayed according to a user manipulation (for example, a UI screen may be changed by a direction key). Thus, a user may be inconvenienced while searching for an item included in the virtual remote controller.

### SUMMARY

One or more exemplary embodiments provide a display apparatus for providing a virtual remote controller which is divided into a plurality of UI areas including items with different respective properties on one screen, and a display method thereof.

One or more exemplary embodiments also provide a display apparatus which, when a cursor is located at one item of a virtual remote controller which is divided into a plurality of UI areas including items with different respective properties magnifies a size of the UI area where a corresponding item is included or displays additional information regarding the corresponding item together, and a display method thereof.

According to an aspect of an exemplary embodiment, there is provided a display method of a display apparatus which includes receiving a command to display a virtual remote controller, displaying a virtual remote controller which is divided into a plurality of user interface (UI) areas which include items with different properties according to the received command, magnifying a size of one UI area from among the plurality of UI areas according to a received manipulation, and displaying additional information regarding at least one item included in the magnified UI area.

The method may further include displaying a cursor capable of moving on the virtual remote controller according to the received manipulation, and the magnifying may include magnifying a size of a UI area including an item where the cursor is located.

The displaying additional information may include displaying additional information regarding an item where the cursor is located.

Additional information regarding each item of a UI area where the cursor is located may be displayed at one side of each item.

The plurality of UI areas may include at least one of a first UI area which includes a plurality of number buttons, a second UI area which includes a plurality of control menus, and a third UI area which includes a plurality of hot keys.

The method may further include magnifying at least one of a size of at least one item and a distance between items included in the magnified UI area.

The method may further include reducing a size of each of the plurality of UI areas except for the magnified UI area.

According to an aspect of an exemplary embodiment, there is provided a display apparatus according to an exemplary embodiment includes a receiver configured to receive a command to display a virtual remote controller, a display configured to display a virtual remote controller which is divided into a plurality of UI areas which include items with different properties according to the received command, and a controller configured to magnify a size of one UI area from among the plurality of UI areas according to a received manipulation, and configured to control display of additional information regarding at least one item included in the magnified UI area.

The controller may display a cursor capable of moving on the virtual remote controller according to the received manipulation, and magnify a size of a UI area including an item where the cursor is located.

The controller controlling display of additional information comprises displaying additional information regarding an item where the cursor is located.

The controller may control to display additional information regarding each item of a UI area where the cursor is located at one side of each item.

The plurality of UI areas may include at least one of a first UI area which includes a plurality of number buttons, a second UI area which includes a plurality of control menus, and a third UI area which includes a plurality of hot keys.

The controller may magnify at least one of a size of at least one item and a distance between items included in the magnified UI area.

The controller may reduce a size of each of the plurality of UI areas except for the magnified UI area.

According to the various exemplary embodiments, a virtual remote controller which is divided into a plurality of UI areas including items with different properties, respectively is provided on one screen and thus, user convenience can be improved.

### BRIEF DESCRIPTION OF THE DRAWINGS

The above and/or other aspects of the present inventive concept will be more apparent by describing certain exemplary embodiments with reference to the accompanying drawings, in which:

FIG. 1 is a view illustrating a display apparatus according to an exemplary embodiment;

FIG. 2 is a block diagram illustrating a display apparatus according to an exemplary embodiment;

FIGS. 3 to 5 are views illustrating operations of a virtual remote controller according to exemplary embodiments;

FIGS. 6 to 8 are views illustrating operations of a virtual remote controller according to exemplary embodiments;

FIG. 9 is a view illustrating an operation of a plurality of web pages according to an exemplary embodiment;

FIG. 10 is a view illustrating a remote controller according to an exemplary embodiment; and

FIG. 11 is a flowchart illustrating a display method of a display apparatus according to an exemplary embodiment.

### DETAILED DESCRIPTION

It should be observed the method steps and system components have been represented by conventional symbols in the figure, showing only specific details which are relevant for an understanding of the present disclosure. Further, details may be readily apparent to person ordinarily skilled in the art may not have been disclosed. In the present disclosure, relational terms such as first and second, and the like, may be used to distinguish one entity from another entity, without necessarily implying any actual relationship or order between such entities.

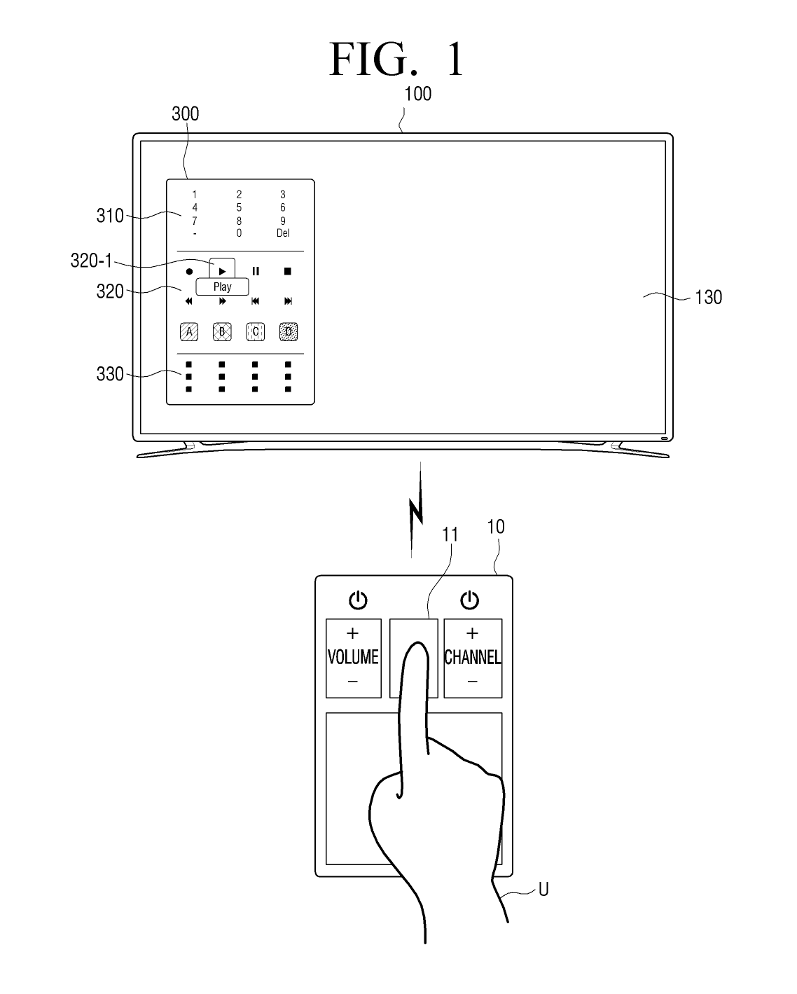

FIG. 1 is a view illustrating a display apparatus according to an exemplary embodiment.

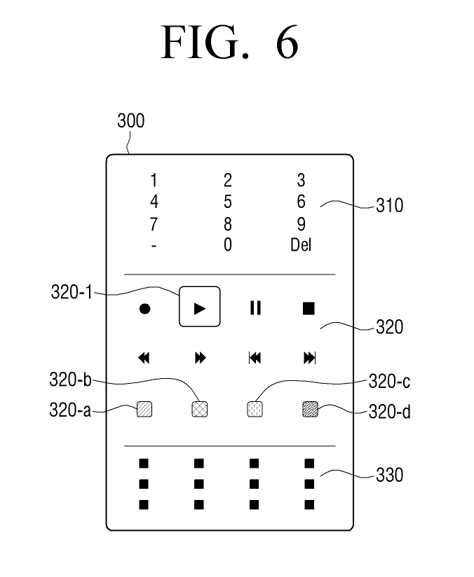

According to FIG. 1, a display apparatus 100 provides a broadcast to a user (U) by displaying the broadcast received through a broadcast medium on the display 130. In addition, the display 100 may provide a web page received via the Internet to a user by displaying the web page on the display 130. A remote controller 10 may have a virtual remote controller button 11. The remote controller 10 may transmit a control command to the display apparatus 100 by using IR, Bluetooth, WiFi, etc. The detailed structure of the remote controller 10 is described below with reference to FIG. 6.

Meanwhile, if the virtual remote controller button 11 on the remote controller 10 is selected by a user U, the display apparatus 100 may display a virtual remote controller 300 on the display 130. The virtual remote controller 300 does not have a physical shape such as a key button of a remote controller, but may include a group of menu items displayed on the screen of the display 130 of the display apparatus 100. FIG. 1 illustrates that a first user interface (UI) area 310 (e.g., a number item area), a second UI area 320 (e.g., a playback/color key item area), and a third UI area 330 (e.g., a hot key item area) are displayed on the display 130. The group of items may have different properties (for example, number, items for control, etc.), may be divided into a plurality of areas, and may be displayed on one screen.

As illustrated in FIG. 1, a selection Graphic User Interface (GUI) (for example, a cursor 320-1) may be located at a center of the virtual remote controller 300. The cursor 320-1 is shown in FIG. 1 at the playback/color key item area 320. The playback/color key item area 320 where the cursor 320-1 is located may appear larger than the number item area 310 and the hot key item area 330. Additional information such as the word ‘Play’ may optionally be displayed on one side of an item where the cursor 320-1 is located. The additional information may include various information associated with items, such as text information, icons, pictures, etc.

Meanwhile, although the above-described item areas are described with respect to the number item area 310, the playback/color key item area 320, and the hot key area 330, various items may be located in the divided areas.

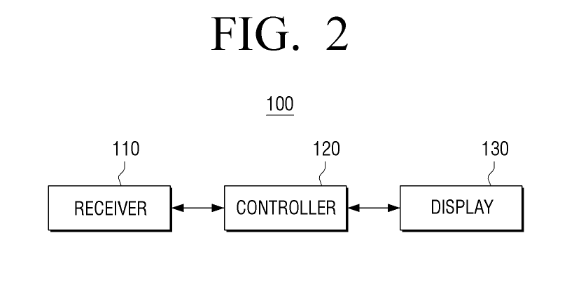

FIG. 2 is a block diagram illustrating a display apparatus according to an exemplary embodiment.

According to FIG. 2, the display apparatus 100 may include a receiver 110, a controller 120, and a display 130. In addition, the display apparatus 100 may further include a broadcast receiver, a broadcast processor, a GUI generator, and an audio output unit.

The display apparatus 100 may provide a broadcast which is received via cable or a wireless connection and displayed to a user through a display screen. In addition, the display apparatus 100 may provide a user with not only an external input received from an external apparatus connected via cable or wirelessly through a display screen, but also via a file (e.g., a video file, a still image file, a music file, etc.) which may be stored in an included storage medium. Further, the display apparatus 100 may both receive and provide various video, audio, and Internet Protocol (IP) packets, etc., and may provide them to a user.

The display apparatus 100 which receives and outputs a broadcast signal may be realized as a digital television, but is not limited thereto. The display apparatus 100 may be realized as any apparatus which may receive a broadcast signal, such as, for example, a mobile phone, Portable Media Player (PMP), MP3 Player, Personal Computer (PC), etc.

The display apparatus 100 may divide a screen of the display 130 into a plurality of screens and provide them to a user. Each of the divided screens may display different contents. Herein, the contents may be images, external inputs, Internet packets received via the Internet, cable images, etc., and may also be any service which can be provided to a user through the screen. Meanwhile, the display apparatus 100 may also communicate with a remote controller 10 having a touch panel including a user input function.

The receiver 110 may receive a virtual remote controller display command (e.g., a received command) from a remote controller 10. Herein, the virtual remote controller display command refers to a command to display a virtual remote controller 300 on the display 130. The virtual remote controller 300 refers to a group of menu items displayed on the display 130, which do not have a required physical shape such as a key button of a remote controller, as described above. In addition, the receiver 110 may transmit a received control command to the controller 120. The control command may be a power on/off command, a volume control command, a channel change command, an external signal command, a hot key command, etc.

The display 130 may display a virtual remote controller 300 which is divided into a plurality of UI areas including items with different respective properties. If an external input signal is received through the receiver 110, corresponding contents may be displayed on the display 130 in accordance with the received external input signal. The display 130 may support 4096 pixels (4K) in width and 2048 pixels (2K) in length. The display 130 may be not only a backlit Liquid Crystal Display (LCD) or Light Emitting Diode (LED) display, but also may be a self-emitting display such as Organic Light Emitting Diodes (OLED), Plasma Display Panel (PDP), etc.

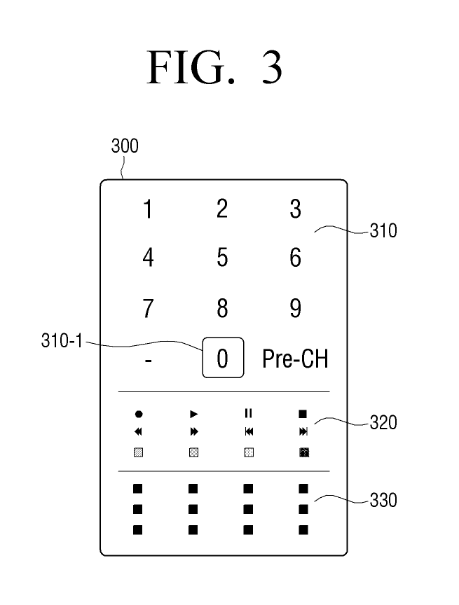

The controller 120 may magnify a plurality of UI areas which constitute a virtual remote controller 300 according to user manipulation. Herein, a user may manipulate the virtual remote controller 300 by using a touch pad of the remote controller 10. Specifically, a user may manipulate the virtual remote controller 300 through the motion of contacting the touch pad with a finger, a touch pen, etc., which will be described in detail with reference to FIGS. 3 to 5.

The controller 120 may display a cursor (e.g., 310-1, 320-1, and 330-1 as shown in FIGS. 3, 4, and 5 respectively) which moves on the virtual remote controller 300 according to the user manipulation (e.g., a received manipulation), and may magnify the size of a UI area which includes the item where the cursor is located, which will be described with reference to FIGS. 3 to 5.

The controller 120 may display additional information regarding the item where the cursor is located. For example, the controller 120 may display a function regarding the corresponding item or may display information regarding the corresponding item which is stored in the storage.

The controller 120 may display additional information regarding each of the items in a UI area including the item where the cursor is located at a side of each item. Specifically, the controller 120 may display additional information regarding each of the items in a UI area including the item where the cursor is located from among a plurality of UI areas, including items with different respective properties at a side of each item, as described in detail with reference to FIGS. 3 to 5.

The virtual remote controller 300 may be divided into a plurality of UI areas, and the plurality of UI areas may include at least one of a first UI area 310 which includes a plurality of number buttons, a second UI area 320 which includes a plurality of control menus, and a third UI area 330 which includes a plurality of hot keys. For example, the first UI area 310 may have numbers from 0 to 9, and may further include an item displaying a viewing history. If a cursor (e.g., 310-1, 320-1, 330-1) is located at a Pre-Ch item which displays a viewing history, the controller 120 may display on the display 130 a list of channels that a user has watched previously, which may be stored in a storage unit of controller 120. In addition, the second UI area 320 which may include control menus may have a playback menu item for playing a video, MP3, etc., and a color key for performing a control function, etc. The third UI area 330 may include a plurality of hot keys. For example, hot keys may be provided to perform 3D screen conversion, screen magnification/reduction, subtitle setting, etc.

The controller 120 may magnify at least one of the size of at least one item included in a magnified UI area from among the plurality of UI areas and the distance between items. For example, the magnified UI area may be the UI area where the cursor is located.

The controller 120 may reduce the size of UI areas other than the magnified UI area from among the plurality of UI areas. The controller 120 may reduce the UI areas where the cursor is not located. The controller 120 may reduce the UI areas themselves, reduce the size of items located in the UI areas, or reduce the distance between the items located in the UI areas.

Meanwhile, a broadcast receiver may receive a broadcast from a broadcasting station or a satellite provider via cable or wireless connection, and may demodulate the broadcast. In addition, the broadcast processor may perform signal processing such as video decoding, video scaling, audio decoding, etc. with respect to a broadcast output from the broadcast receiver. In addition, the broadcast receiver may transmit an image signal to the GUI generator and transmit an audio signal to an audio output unit, respectively. The GUI generator may generates a GUI to be displayed on the display 130, and may add the generated GUI to an image output from the broadcast processor. The audio output unit may display an image upon which the GUI output from the broadcast receiver is added. The storage may store various functions and information under the control of the controller 120. The storage may consist of Double Data Rate (DDR) Random-Access Memory (RAM), Read-only Memory (ROM), flash memory, Compact Disc (CD)/Digital Versatile Disc (DVD), etc.

FIGS. 3 to 5 are views illustrating an operation of a virtual remote controller according to exemplary embodiments.

According to FIG. 3, the virtual remote controller 300 displayed on the display 130 may be divided into a plurality of UI areas including items with different respective properties. There is no limit to the items disposed on the plurality of UI areas. For example, FIG. 2 illustrates the first UI area 310 which includes a plurality of number buttons, the second UI area 320 which includes a plurality of control menus, and the third UI area 330 which includes a plurality of hot keys as an exemplary embodiment.

The first UI area 310 may include a number key and a Pre-Ch item for displaying a viewing history as described above. In addition, a Del item may be provided instead of the Pre-Ch item. As illustrated in FIG. 3, a cursor 310-1 may be located at the number, ‘0’ of the first UI area 310. According to a virtual remote controller display command received from a remote controller 10, the controller 120 may display the virtual remote controller 300 on the display 130, and set the cursor 310-1 to be located at a specific item. The cursor 310-1 optionally may not be located at any item and instead, may be set to be displayed when there is a user manipulation. The shape of the cursor may be realized in various ways as long as it permits focus on an item. That is, the shape of the cursor may not necessarily be only a square.

As the cursor 310-1 is located, for example, at the number, ‘0’, the controller 120 may magnify the first UI area 310 which includes a plurality of number buttons where the cursor is located. In this case, if additional information is associated with the number, it may also be displayed.

As shown in the exemplary embodiment illustrated in FIG. 3, the second UI area 320 including a plurality of control menus and the third UI area 330 including a plurality of hot keys, where the cursor 310-1 is not located, may be smaller than the first UI area 310 including a plurality of number buttons, where the cursor 310-1 is located. The items included in the second UI area 320 which includes a plurality of control menus and the third UI area 330 which includes a plurality of hot keys may be displayed in a smaller size. Even if the items in the UI areas 320, 330 where the cursor is not located include additional information, the additional information may not be displayed. Alternatively, if the items in the UI areas 320, 330 where the cursor 310-1 is not located include additional information, the icons of the items may not be displayed and only the additional information may be displayed. The controller 120 may reduce the distance between items in the UI areas 320, 330 where the cursor 310-1 is not located in the exemplary embodiment of FIG. 3.

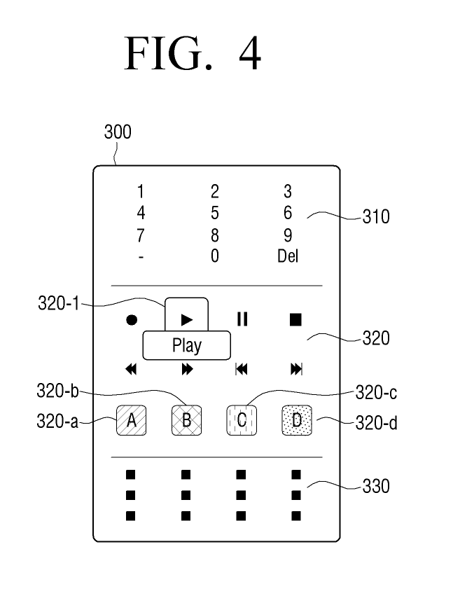

In this case, a user may move the cursor to the UI areas 320, 330 where the cursor is not located by using a touch pad on the remote controller 10. FIG. 4 illustrates when a user moves the cursor (now shown as 320-1) to the second UI area 320 which includes a plurality of control menus.

According to FIG. 4, the cursor 320-1 may be located at a play item according to a touch command from a user. As the cursor is located at the second UI area 320 which includes a plurality of control menus, a size of the first UI area 310 which includes a plurality of number buttons may be reduced. For example, the controller 120 may reduce a size of the first UI area 310 by reducing the size of the items of the first UI area 310 or the distance between the items. Alternatively, the size of the second UI area 320 which includes a plurality of control menus where the cursor 320-1 is located may be magnified by magnifying the size of the items of the second UI area 320 or the distance between the items.

In the exemplary embodiment illustrated in FIG. 4, the controller 120 may determine whether additional information is included in the play item corresponding to where the cursor 320-1 is located, and may display additional information corresponding to a play item stored in the storage. In addition, the controller 120 may also display additional information included in color key items 320-a, 320-b, 320-c, 320-d of the second UI area 320.

When hot key items are located in the third UI area 330 which includes a plurality of hot keys, the controller 120 may display only additional information included in the hot key items or may display only icons of the hot key items.

In addition, a Del item may be presented instead of the Pre-Ch item located in the first UI area 310. The Del item may indicate a Delete item to delete a number.

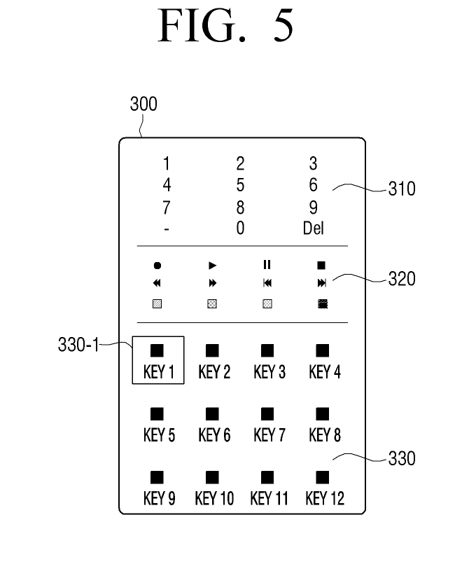

A user may move the cursor 320-1 to the UI areas 310, 330 where the cursor is not located in FIG. 4 by using a touch pad of the remote controller 10. FIG. 5 illustrates when a user moves the cursor to the third UI area 330 which includes a plurality of hot keys.

According to FIG. 5, a cursor 330-1 may be located at a hot key item according to a touch command from a user. As the cursor 330-1 is located at the third UI area 330 which includes a plurality of hot keys, a size of the second UI area 320 which includes a plurality of control menus may be reduced. The controller 120 may reduce a size of the second UI area 320 by reducing the size of the items of the second UI area 320 or the distance between the items. On the other hand, the size of the third UI area 330 which includes a plurality of hot keys where the cursor 330-1 is located may be magnified by magnifying a size of the items of the third UI area 330 or the distance between the items.

In this case, the controller 120 may determine whether additional information is included in the hot key item where the cursor 330-1 is located and may display the additional information corresponding to a hot key item which may be stored in the storage. In addition, the controller 120 may also display additional information of all items included in the third UI area 330 at one side of the items. In this case, in the case of items including a control menu located on the second UI area 320, the controller 120 may display only additional information included associated with the items or may display only the icons of the items displaying a control menu. For example, only ‘Play’ of a play menu may be displayed, or only an icon of the play menu may be displayed.

Meanwhile, FIGS. 6 to 8 are views illustrating operations of a virtual remote controller according to exemplary embodiments.

According to FIG. 6, the cursor 320-1 may be located at a play item according to a touch command from a user. As the cursor 320-1 is located at the second UI area 320 including a plurality of control menus, a size of the first UI area 310 which includes a plurality of number buttons may be reduced. The controller 120 may reduce a size of the first UI areas by reducing items of the first UI area 310 or the distance between the items. Alternatively, a size of the second UI area 320 which includes a plurality of control menus where the cursor 320-1 is located may be magnified. However, a size of the items included in the second UI area 320 may not be magnified. However, the distance between the items included in the second UI area 320 may be magnified.

In this case, even if additional information is associated with the play item where the cursor 320-1 is located, the controller 120 may not display the additional information.

Alternatively, icons of the items may not be displayed, and only the additional information included associated with the items may be displayed.

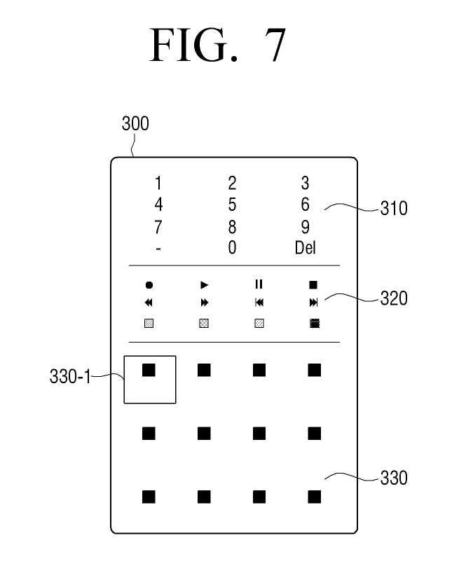

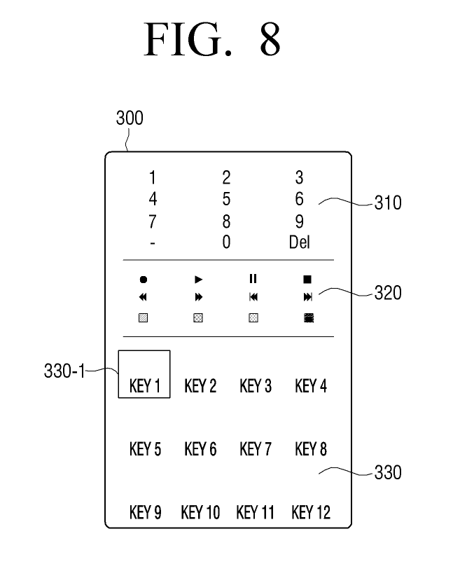

A user may move the cursor to the UI areas 310, 330 where the cursor is not located in FIG. 6 by using a touch pad of the remote controller 10. FIG. 7 and FIG. 8 illustrate when a user moves the cursor 320-1 to the third UI area 330 which includes a plurality of hot keys.

According to FIG. 7, the cursor 330-1 may be located at a hot key item according to a touch command from a user. As the cursor 330-1 is located at the third UI area 330 which includes a plurality of hot keys, a size of the second UI area 320 which includes a plurality of control menus may be reduced. The controller 120 may reduce a size of the second UI area 320 by reducing the items of the second UI area 310 or the distance between the items. Alternatively, a size of the third UI area 330 which includes a plurality of hot keys where the cursor is located may be magnified. However, a size of items included in the third UI area 320 may be fixed, and only the distance between the items may be magnified.

Thus, even if additional information is associated with a hot key item where the cursor 330-1 is located, the controller 120 may not display additional information corresponding to the item 330-1 which may be stored in the storage, and may display only icons of the items. In the case of the items including a control command disposed on the second UI area 320, the controller 120 may display only the additional information associated with the items, or may display only icons of the items displaying a control menu. For example, the controller 120 may display only ‘Play’ of a play menu, or display only an icon of the play menu.

In addition, the controller 120 may display only the additional information associated with the items as illustrated in the exemplary embodiment shown in FIG. 8.

The detailed operation of FIG. 8 corresponds with the operation of FIG. 7, thus a more detailed discussion is omitted.

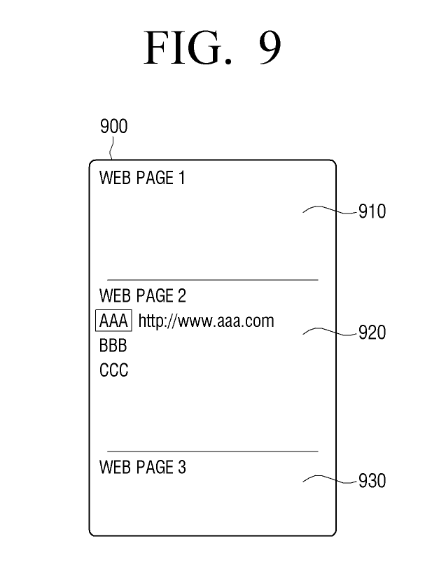

FIG. 9 is a view illustrating an operation corresponding to a plurality of web pages according to an exemplary embodiment.

According to FIG. 9, a plurality of web pages are displayed on a display area 900 of a screen of a display apparatus (e.g., web page 1, web page 2, and web page 3 may be displayed at areas 910, 920, and 930 respectively). If a screen focus is on AAA of web page 2 at area 920 of display area 900 according to a user manipulation, additional information associated with the AAA item is displayed together with AAA in area 920. For example, a link address or additional information may be displayed. If the screen focus is on web page 1, a screen size of web page 1 may be magnified as described above in detail with reference to FIGS. 3 to 8, so further description is omitted.

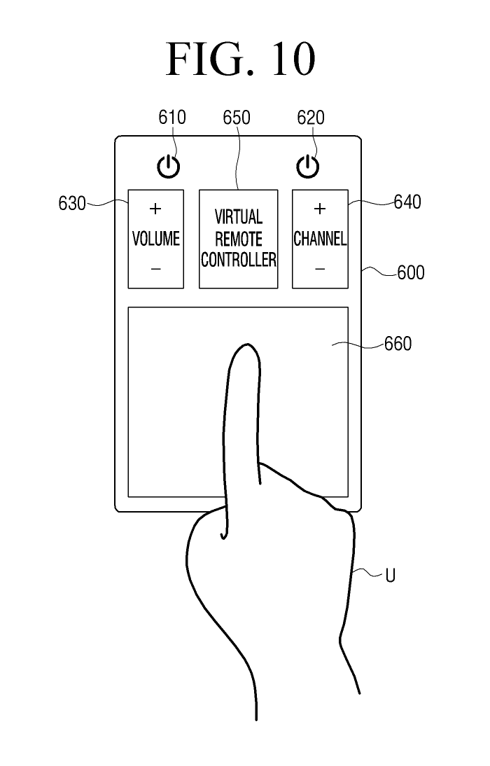

FIG. 10 is a view illustrating a remote controller 600 according to an exemplary embodiment.

According to FIG. 10, a remote controller 600 may include a display apparatus power button 610, a set-top box power button 620, a volume button 630, a channel button 640, a virtual remote controller execution button 650, and a touch pad 660.

The remote controller 600 may control the display apparatus 100. The remote controller 600 may communicate with the display apparatus 100 by using IR, Bluetooth, WiFi, etc.

A user U may turn on or turn off the power of the display apparatus 100 by using the display apparatus power button 610. A user may turn on or turn off the power of a set-top box by using the set-top box power button 620. In addition, a user may increase/decrease volume by using the volume button 630, and may change a channel by using the channel button 640.

If the virtual remote controller button 650 is pressed by a user, the remote controller 600 may transmit a command to display a virtual remote controller 300 on the display 130 of the display apparatus 100 to the display apparatus 100. The display apparatus 100 may receive the command from the remote controller 600 through the receiver 110, and the controller 120 may display the virtual remote controller 300 on the display 130 according to the corresponding command.

When a virtual remote controller 300 is displayed on the display 130, the user may move the cursor on the virtual remote controller 300 using touch pad 660, as described in detail with reference to FIGS. 3 to 5.

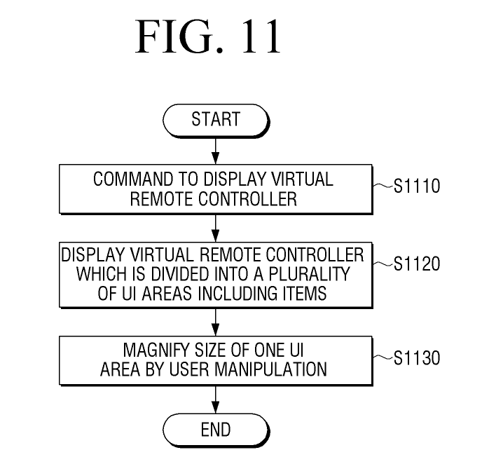

FIG. 11 is a flowchart illustrating a display method of a display apparatus according to an exemplary embodiment.

According to FIG. 11, a display method of a display apparatus according to an exemplary embodiment may be performed as follows.

Initially, the display apparatus 100 receives a command to display a virtual remote controller from a remote controller (S1110).

Subsequently, a virtual remote controller which is divided into a plurality of UI areas which include items with different respective properties is displayed according to the command (S1120). Various items may be located in the plurality of UI areas. In an exemplary embodiment, items with different properties may be displayed on each of the UI areas, but this is only an example. The items with different properties may be disposed in one UI area.

The size of one UI area from among the plurality of UI areas is magnified (S1130). In this case, the user manipulation may be generated by a touch command of a touch pad of the remote controller. The magnified UI area may be an area where a cursor is located.

In addition, the display method of a display apparatus according to an exemplary embodiment may further include displaying a cursor which moves according to user manipulation. The cursor may be located at one item as a default, or may be activated when a user's touch command is input.

Magnification may include magnifying a size of a UI area which includes the item where the cursor is located. The display apparatus 100 may magnify the UI area including the item where the cursor is located, magnify the size of items included in a corresponding UI area, or may magnify the distance between items.

In addition, the above display method of a display apparatus may further include displaying additional information regarding the item where the cursor is located. The additional information regarding the item may be stored in the display apparatus 100. When the cursor is focused on the corresponding item, the corresponding additional information may be displayed at one side of the item.

Further, additional information regarding each of the entire items of a UI area including the item where the cursor is located may be displayed on one area of each item. Specifically, each of the entire items of the UI area including the item where the cursor is located may include additional information. The additional information may be displayed at one side of each item. For example, additional information such as ‘Play’ may be displayed on a play item.

The virtual remote controller 300 may be divided into a plurality of UI areas, and the plurality of UI areas may include at least one of a first UI area which includes a plurality of number buttons, a second UI area which includes a plurality of control menus, and a third UI area which includes a plurality of hot keys. However, while such an exemplary embodiment describes the above UI areas, it merely provides an example. The virtual remote controller 300 may be divided into various UI areas including various items.

In addition, the display apparatus 100 may magnify at least one of a size of at least one item or a distance between items included in the magnified UI area from among the plurality of UI areas. Herein, the magnified UI area may be an area where the cursor is located.

Further, the display apparatus 100 may reduce a size of UI areas except for a magnified UI area from among the plurality of UI areas. The controller 120 may reduce the size of the UI areas where the cursor is not located. The controller 120 may reduce the UI area, a size of items in the UI area, or a distance between items in the UI area.

Meanwhile, the display method of a display apparatus according to various exemplary embodiments may be realized as a program and may be provided in an image adjusting apparatus. Specifically, a non-transitory computer readable medium storing a program which includes the steps of receiving a command to display a virtual remote controller from a remote controller, displaying a virtual remote controller which is divided into a plurality of UI areas including items with different properties according to the command, and magnifying the size of one UI area from among a plurality of UI areas according to a user manipulation may be provided.

The non-transitory recordable medium refers to a medium which may store data semi-permanently rather than storing data for a short time such as a register, a cache, and a memory and may be readable by an apparatus. Specifically, the above-described various applications or programs may be stored in a non-temporal recordable medium such as CD, DVD, hard disk, Blu-ray disk, USB, memory card, ROM, etc. and provided therein.

The foregoing embodiments are merely exemplary and are not to be construed as limiting. The exemplary embodiments can be readily applied to other types of apparatuses. Also, the description of the exemplary embodiments is intended to be illustrative, and not to limit the scope of the claims, and many alternatives, modifications, and variations will be apparent to those skilled in the art.

What is claimed is:

1. A display method of a display apparatus, comprising:
receiving a command to display a virtual remote controller;
displaying a virtual remote controller which is divided into a plurality of user interface (UI) areas which include items with different properties according to the received command;
magnifying a size of one UI area from among the plurality of UI areas according to a received manipulation; and
displaying additional information regarding at least one item included in the magnified UI area.

2. The method as claimed in claim 1, further comprising:
displaying a cursor capable of moving on the virtual remote controller according to the received manipulation,
wherein the magnifying comprises magnifying a size of a UI area including an item where the cursor is located.

3. The method as claimed in claim 2, wherein the displaying additional information comprises displaying additional information regarding an item where the cursor is located.

4. The method as claimed in claim 2, wherein additional information regarding each item of a UI area where the cursor is located is displayed at one side of each item.

5. The method as claimed in claim 1, wherein the plurality of UI areas include at least one of a first UI area which includes a plurality of number buttons, a second UI area which includes a plurality of control menus, and a third UI area which includes a plurality of hot keys.

6. The method as claimed in claim 1, further comprising:
magnifying at least one of a size of at least one item and a distance between items included in the magnified UI area.

7. The method as claimed in claim 1, further comprising:
reducing a size of each of the plurality of UI areas except for the magnified UI area.

8. A display apparatus, comprising:
a receiver configured to receive a command to display a virtual remote controller;
a display configured to display a virtual remote controller which is divided into a plurality of user interface (UI) areas which include items with different properties according to the received command; and
a controller configured to magnify a size of one UI area from among the plurality of UI areas according to a received manipulation, and configured to control display of additional information regarding at least one item included in the magnified UI area.

9. The apparatus as claimed in claim 8, wherein the controller displays a cursor capable of moving on the virtual remote controller according to the received manipulation, and magnifies a size of a UI area including an item where the cursor is located.

10. The apparatus as claimed in claim 9, wherein the controller controlling display of additional information comprises displaying additional information regarding an item where the cursor is located.

11. The apparatus as claimed in claim 9, wherein the controller controls to display additional information regarding each item of a UI area where the cursor is located at one side of each item.

12. The apparatus as claimed in claim 8, wherein the plurality of UI areas include at least one of a first UI area which includes a plurality of number buttons, a second UI area which includes a plurality of control menus, and a third UI area which includes a plurality of hot keys.

13. The apparatus as claimed in claim 8, wherein the controller magnifies at least one of a size of at least one item and a distance between items included in the magnified UI area.

14. The apparatus as claimed in claim 8, wherein the controller reduces a size of each of the plurality of UI areas except for the magnified UI area.

15. A display apparatus, comprising:
a display configured to display a virtual controller which is divided into a plurality of user interface (UI) areas, each UI area comprising a plurality of selectable items; and
a controller configured to manipulate a size of at least one UI area from among the plurality of UI areas according to a received manipulation command obtained as input corresponding to the virtual controller, and configured to control display of additional information corresponding to at least one item included in the at least one UI area.

16. The apparatus as claimed in claim 15, wherein the controller is configured to display additional information regarding at least one item of a UI area where a virtual controller cursor is located on the display.

17. The apparatus as claimed in claim 15, wherein the controller is configured to move a virtual controller cursor responsive to a received movement command.

18. The apparatus as claimed in claim 17, wherein the controller is configured to manipulate display of the plurality of UI areas responsive to a command to move the virtual controller cursor from a current UI area of the plurality of UI areas to a new UI area of the plurality of UI areas.

19. The apparatus as claimed in claim 18, wherein the controller manipulates display of the plurality of UI areas by decreasing a size of at least one item of the current UI area of the plurality of UI areas and increasing a size of at least one item of the new UI area of the plurality of UI areas.

20. A remote controller apparatus, comprising:
a virtual control input configured to designate a virtual control display command;
a touch pad unit configured to receive a touch-based input; and
a transmitter configured to transmit the virtual control display command to a display apparatus to cause the display apparatus to display a virtual controller, and configured to convert a touch-based input of the touch pad unit to a display cursor command and transmit the display cursor command to the display unit to perform an operation corresponding to a cursor of the virtual controller on the display apparatus.
